(19) United States
(12) Patent Application Publication
(10) Pub. No.: US 2003/0137391 A1
(43) Pub. Date: Jul. 24, 2003

(54) Circuit breaker

(76) Inventor: Albert Huang, Taipei (TW)

Correspondence Address: BACON & THOMAS, PLLC, 625 SLATERS LANE, FOURTH FLOOR, ALEXANDRIA, VA, 22314

(21) Appl. No.: 10/052,271

(22) Filed: Jan. 23, 2002

(51) Int. Cl. H01H 71/16; H01H 71/58

(52) U.S. Cl. 337/66; 337/68; 337/72

(57) ABSTRACT

A circuit breaker includes a housing having an open top and a closed bottom, with a button pivotally connected to the housing at the open top, and with a grounding prong, an output blade and an input blade extending out of the housing through the closed bottom. The output blade has an inner end provided with a first contact. The input blade has an inner end formed with a bimetal strip that is provided with a second contact normally engaged with the first contact. The button is further formed with a leg extending towards the strip, and a hook is pivotally connected to the leg and has an arm beneath the strip. A neon indicator has first and second terminals. The second terminal is electrically connected to the output blade, and a resistor is electrically connected between the grounding prong and the first terminal of the neon indicator.

### BACKGROUND OF THE INVENTION

1. Field of the Invention

The present invention relates to a circuit breaker and, more particularly, to a circuit breaker which is simple in structure and easy to be assembled.

2. Description of Related Art

There are various types of circuit breakers. As shown in FIG. 4, one of them includes a hollow body (40) having an open top and a closed bottom, with the closed bottom defining three slots (41, 42, 42) through which a grounding prong (44), an output blade (45) and in input blade (46) extend downward out of the hollow body (40), respectively.

As clearly shown, the output blade (45) has a bent inner end provided with a first contact (451), while the input blade (46) has a bent inner end formed with a laterally extending bimetal strip (48) that is provided with a second contact (481) normally engaged with the first contact (451) of the output blade. (45).

At the open top of the hollow body (40), there is a button (50) pivotal about an axle (51). The button (50) is formed with a pair of opposed sidewalls (52), one behind another, and with a leg (60) having a pair of opposed upper lugs (62) situated between and pivotally connected to the sidewalls (52) by a pintle (53). Also pivotally connected to the sidewalls (52) by the same pintle is a hook (65) that has a lower arm beneath the bimetal strip (48).

The leg (60) has a boss (61) slidable into a semi-circular recess (49) defined in an inner wall of the hollow body (40), and a first protrusion (601) opposed to the boss (61). The hollow body (40) defines therein a compartment (491) for receiving a holder (64) that has a second protrusion (641) opposite to the first protrusion (601) of the leg (60).

It is between the protrusions (601, 641) that a spring (63) is compressed so as to press the boss (61) of the pivotal leg (60) against the inner wall of the body (40).

Referring to FIG. 5, the bimetal strip (48) will become heated and curved upward if an electric overcurrent goes through it as well as the blades (45, 46). The now-curved bimetal strip (48) then pushes the leg (60) upward and hence turns the button (50) clockwise, until the boss (61) of the pivotal leg (60) slides into the semi-circular recess (49) of the body (40) by the action of the compressed spring (63).

From then on, the bimetal strip (48) is retained in this curved position by the lower arm of the hook (65) and the contacts (481, 45) are disengaged from each other, unless the button (50) is manually turned counterclockwise again.

It is apparent that this conventional circuit breaker is excessively complex in its structure and has so many parts that must be fabricated.

Furthermore, the hollow body (40) is designed to be covered with a front cover (not shown), which is jointed to the body (40) by several rivets extending through respective sleeves (47) on the body (40). The manual riveting makes the circuit breaker difficult to be assembled.

Therefore, it is an objective of the invention to provide a circuit breaker to mitigate and/or obviate the aforementioned problems.

### SUMMARY OF THE INVENTION

The object of the present invention is to provide a circuit breaker which is simple in structure.

Another object of the present invention is to provide a circuit breaker which is easy to be assembled.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a preferred embodiment of a circuit breaker in accordance with the present invention;

FIG. 2 is a front view, with a front cover removed, showing the circuit breaker of FIG. 1 in its switched-on position;

FIG. 3 is a front view, also with the front cover removed, showing the circuit breaker of FIG. 1 in its switched-off position;

FIG. 4 is a front view of a conventional circuit breaker in its switched-on position; and

FIG. 5 is a front view of the conventional circuit breaker of FIG. 4 in its switched-off position.

### DETAILED DESCRIPTION OF THE PREFERRED EMBODIMENT

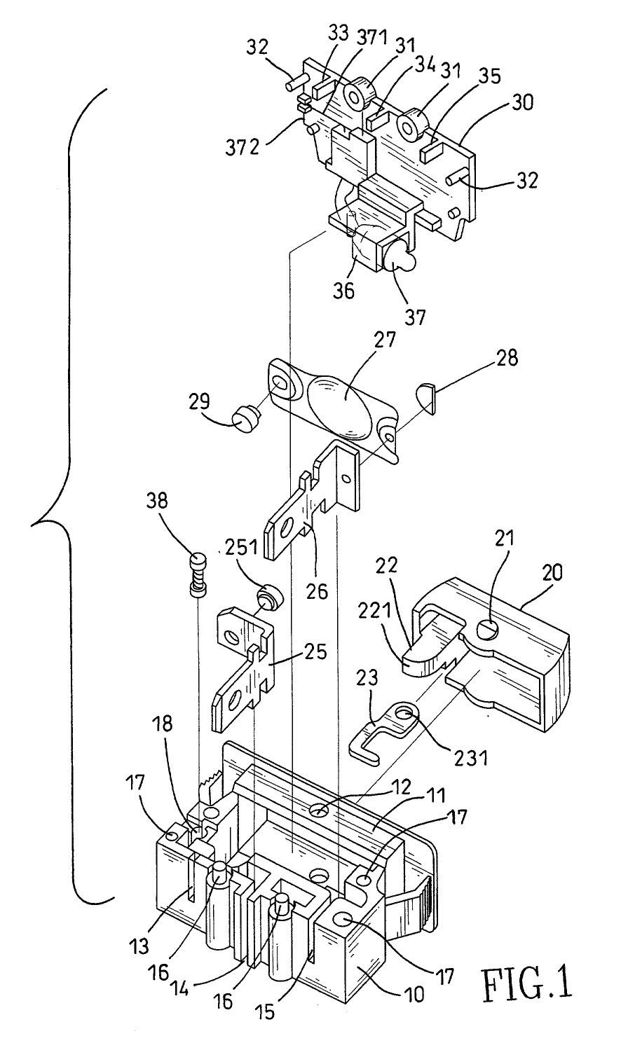

Referring to FIG. 1, a circuit breaker in accordance with the present invention includes a housing which is configured as a hollow body (10) covered with a front cover (30).

The hollow body (10) and the front cover (30) are both made of plastic, with the body (10) formed with a plurality of posts (16) extendible through sleeves (31) of the cover (30). The cover (30) is formed with a plurality of a plurality of pins (32) extendible through orifices (17) in the body (10). This design allows the body (10) and the cover (30) to be jointed together easily and quickly by thermally bonding them at distal ends of the posts (16) and pins (32).

The housing has an open top defined in the hollow body (10) to receive a button (20), which is pivotally connected to the hollow body (10) at the open top. Preferably, the button (20) is pivotally connected by means of a pair of stubs (21) (only one is shown) that extend into apertures (12) defined in upper sidewalls (11) of the body (10).

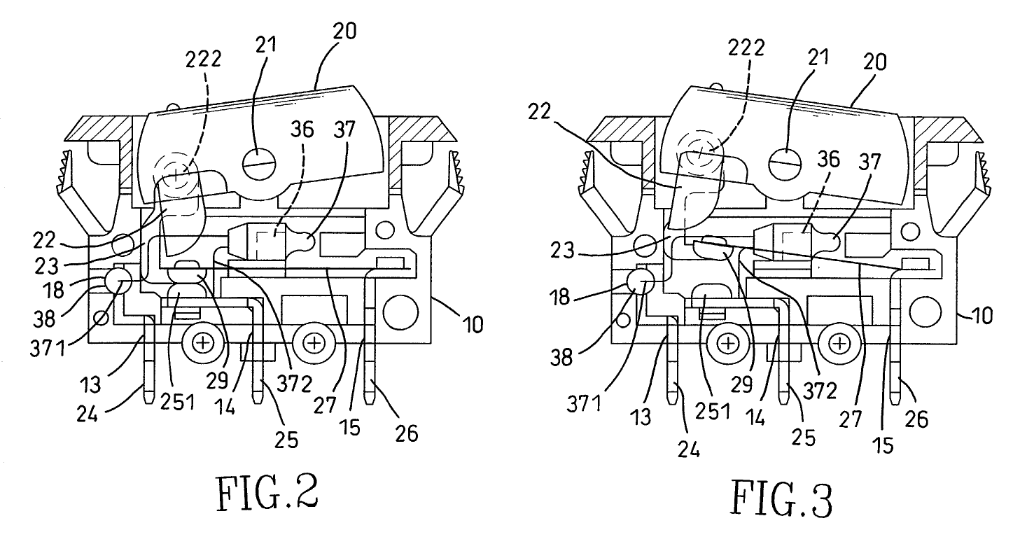

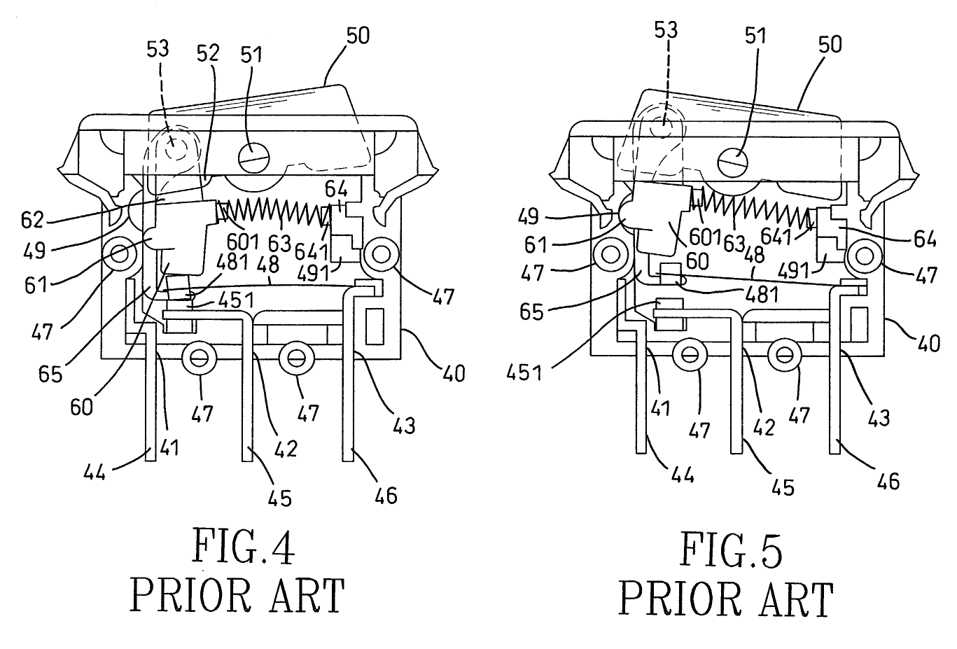

The housing further has a closed bottom preferably formed at the hollow body (10). This closed bottom defines three slots (13, 14, 15) through which a grounding prong (24), an output blade (25) and an input blade (26) extend downward out of the hollow body (10) respectively, as clearly shown in FIG. 2. The grounding prong (24) and the blades (25, 26) are so configured that they may be securely held in the slots (13, 14, 15) by respective tabs (33, 34, 35) of the cover (30).

Referring to FIG. 2 and still to FIG. 1, the output blade (25) has a bent inner end provided with a first contact (251). The input blade (26) has a bent inner end formed with a bimetal strip (27) laterally extending therefrom, and the bimetal strip (27) has a distal end provided with a second contact (29) that is normally engaged with the first contact (251) of the output blade (25), thereby electrically connecting the two blades (25, 26) together.

Preferably, the bimetal strip (27) is riveted on the bent inner end of the input blade (26) with a pad (28) atop the strip (27) to reinforce the portion of the strip (27) where it is riveted, as best shown in FIG. 1.

The pivotal button (20) has a leg (22) extending downward towards the distal end of said bimetal strip (27), terminating in a rounded bottom end (221). The leg (22) is additionally formed with a hook (23) pivotally connected thereto, such as by a lateral stem (222) that extends from the leg (22) into a hole (231) of the hook (23). The hook (23) has a lower arm formed beneath the bimetal strip (27).

In the inventive circuit breaker, a neon indicator (37) is held in the hollow body (10) or the housing, by means of a holder (36) formed on the front cover (30), as best shown in FIG. 1. The indicator (37) has a first terminal (371) and a second terminal (372), with the second terminal (372) electrically connected to the output blade (25).

In addition, the hollow body (10) defines a chamber (18) for receiving and holding a resistor (38) therein. The resistor (38) is electrically connected between the grounding prong (24) and the first terminal (371) of the neon indicator (37), and so the neon indicator (37) is normally lit up, indicating the correct connection between the blades (25, 26).

Referring to FIG. 3, the bimetal strip (27) becomes heated and curved upward if an electric overcurrent goes through it as well as the blades (25, 26). The now-curved bimetal strip (27) disengages the second contact (29) from the first contact (251) of the output blade (25), thereby stopping the electric current between the blades (25, 26) and turning off the neon indicator (37).

At the same time, the curved strip (27) moves the rounded bottom end (221) of the leg (22) upward and hence turns the pivotal button (20) clockwise, as viewed in FIG. 3, to a switched-off position. The bimetal strip (27) is then retained in this position by the lower arm of the hook (23), until the button (20) is manually turned counterclockwise, whereby the contacts (251, 29) are brought into contact and the blades (25, 26) are connected again.

Of particular importance is that the resistor (38) between the grounding prong (24) and the neon indicator (37) may prevent sparks from being produced inside the circuit breaker when it is being switched on/off and thus danger from fire is eliminated.

From the above description, it is noted that the invention has the following advantages:

1. Being Simple in Structure:

Because no spring and related members are involved, the inventive circuit breaker is simple in its structure.

2. Being Easy to be Assembled:

Because the posts (16) and pins (32) are provided, the hollow body (10) and the front cover (30) can easily be assembled by thermally bonding them at the distal ends of the posts (16) and pins (32).

3. Being Safe at the Moment of Switching:

Because of the resistor (38) between the grounding prong (24) and the neon indicator (37), sparks may be prevented from being produced inside the circuit breaker when it is switched on/off.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A circuit breaker comprising:
a housing having an open top and a closed bottom, said housing being formed with three slots (13, 14, 15) in said closed bottom;
a grounding prong (24), an output blade (25) and an input blade (26) all extending out of said housing through said slots (13, 14, 15) respectively;
said output blade (25) having an inner end provided with a first contact (251);
said input blade (26) having an inner end formed with a bimetal strip (27) laterally extending therefrom, said bimetal strip (27) having a distal end provided with a second contact (29) normally engaged with said first contact (251) of said output blade (25);
a button (20) pivotally connected to said housing at said open top, said button (20) being formed with a leg (22) extending downward towards said distal end of said strip (27) and a hook (23) pivotally connected to said leg (22) of said button (20), said hook (23) having an arm formed beneath said strip (27);
a neon indicator (37) held in said housing and having a first terminal (371) and a second terminal (372), said second terminal (372) of said neon indicator (37) being electrically connected to said output blade (25);
a resistor (30) held in said housing and electrically connected between said grounding prong (24) and said first terminal (371) of said neon indicator (37).

2. The circuit breaker as claimed in claim 1, wherein said leg (22) of said button (20) terminates in a rounded end.

3. The circuit breaker as claimed in claim 1, wherein said housing includes a hollow body (10) and a front cover (30) jointed together.

4. The circuit breaker as claimed in claim 2, wherein said hollow body (10) is formed with a plurality of posts (16) and orifices (17), and wherein said front cover (30) is formed with a plurality of sleeves (31) receiving said posts (16) and a plurality of pins (32) extending into said orifices (17) of said hollow body (10).

5. The circuit breaker as claimed in claim 3, wherein said hollow body (10) and said front cover (30) are made of plastic, and wherein said posts (16) are thermally bonded to said front cover (30) in said sleeves (31) while said pins (32) are thermally bonded to said hollow body (10) in said orifices (17), thereby joining said hollow body (10) and said front cover (30) together.
